(19) United States
(12) Patent Application Publication
(10) Pub. No.: US 2006/0163401 A1
(43) Pub. Date: Jul. 27, 2006

(54) Spinning type fishing reel with axially adjustable spool by means of bail arm and line roller

(76) Inventor: Homin Song, Franklin Sq., NY (US)

Correspondence Address: Homin SONG, 766 Cypress, Franklin Sq., NY, 11010, US

(21) Appl. No.: 11/339,747

(22) Filed: Jan. 25, 2006

Related U.S. Application Data
(60) Provisional application No. 60/646,627, filed on Jan. 26, 2005.

(51) Int. Cl. A01K 89/01

(52) U.S. Cl. 242/231

(57) ABSTRACT

There is provided a spinning type fishing reel, which can be adjusted to produce different line lays such as front heavy, back heavy, or even line lay without need of any tool nor separate parts regardless of the drag system of the reel, which is accomplished by adjusting the location of line roller of a spinning type fishing reel. The line roller is attached by a screw to the bail arm of the spinning type fishing reel through bail arm's elongated hole, which allows up and down movement of the line roller. The screw assembly may include a screw and a spring lock washer to hold the line roller securely in desired position.

### CROSS RELERENCE TO RELATED APPLICATION

Priority of U.S. Provisional Patent Application Ser. No. 60/646,627, filed Jan. 26, 2005, is hereby claimed and the entire disclosure of the same is incorporated by reference.

### BACKGROUND

A common spinning type reel has a fixed spool and with a rotating arm to wind fishing line onto the spool. Such fishing reel may have front drag, rear drag, center drag or lever drag systems. Generally, a rotor and bail arm assembly attached to the spinning type reel is rotated so as to wind fishing line onto the spool, which is simultaneously itself axially reciprocated back and forth to lay the line onto spool evenly.

Depending on the shape of the spool drum, the fishing line wound on the spool could result in different shapes of the line lay. For example, when the spool drum has larger diameter on the front side, the fishing line wound results in fishing line layer having larger diameter on the front side, i.e., front heavy line. Similarly, if the spool drum has wider back side or even cylinder shape, the fishing line lay formed on the drum would be predetermined by the shape of the drum, i.e., respectively, back heavy line lay or even line lay.

Also, these different line lay shapes can be caused unintentionally due to inevitable inaccuracies in manufacturing and assembly tolerances. Thus, reels from different production lines of same design and specifications may have different tendency creating different shapes of the line lay.

Thickness of fishing line may also be a considerable factor in determining the spool shape. For example, fishing line with small diameter has tendency to result in the front heavy wound, while coarse or large diameter fishing line tends to result in back heavy wound line lay.

These different line lay shapes have different casting properties, and one shape may be more preferable than the others depending upon different situations. For example, if longer cast is desired, the back heavy line lay may be preferred because it allows rapid expel of the fishing line from the spool. When the spool has the back heavy line lay, there is less resistance to the expelling fishing line as it comes off the spool from the previously wound section of the line because center of the cross section of the expelled fishing line sits higher than the previously wounded line. Conversely, when a lightweight lure or stiffer type of line is used, the front heavy line lay may be desirable because the resistance from the previously wounded line avoids entanglement of the fishing line.

One way to alter the shape of the line lay is changing the spool drum from one shape to another, which requires complete disassembly of the fishing reel and would be practical impossible for a general user to perform especially during his or her fishing activities. Also, some manufacturers have recommended to use separate washers to fit over spool shaft to change the height of spool position in relation to the main shaft, e.g., the lower spool sits on the main shaft, the more of front heavy line lay, or the higher the spool on the main shaft, the more of back heavy line lay. However, adjusting spool shape using this method also involves partial disassembly of fishing reel, such as taking spool off, removing alarm sounding system, etc and takes time to make desired adjustments. Further, using this method requires an angler to carry separate washers, which would not be convenient.

U.S. Pat. No. 4,535,953 discloses a rotationally movable spool shaft to adjust the height of the spool. However, this approach cannot be used on fishing reels using front drag system, which represents overwhelming majority of spinning reels in existence. Further, because it involves modification of the entire spool, manufacturing a fishing reel according to this patent is complicated and expensive.

### SUMMARY OF THE INVENTION

According to one aspect of the present invention, a spinning type fishing reel includes a spool axially reciprocating along its spinning axis as winding fishing line, a bail arm having an elongated hole, and a line roller where the line roller and the bail arm are assembled together using a screw, which perforates the elongated hole and the line roller to hold them together, wherein the location of the line roller is adjustable along the longitudinal axis of the elongate hole to alter the lay shape of the fishing line wound on the spool.

According to another aspect of the present invention, the spinning type fishing reel includes a spool, which axially reciprocates along its spinning axis as winding fishing line, a bail arm having an elongated hole, and a line roller, where the line roller is attached to the bail arm by screwing a screw against the line roller through the elongated hole and the location of the line roller is adjustable axially along the elongated axis of the elongate hole to alter the lay shape of the fishing line wound on the spool, wherein the elongated hole has a distal end, a proximal end and a center, which are located so that the fishing line wound on the spool creates front heavy line lay, back heavy line lay or even line lay as the location of the line roller is adjusted respectively to the distal end, the proximal end and the center.

### BRIEF DESCRIPTION OF THE DRAWINGS

FIG. 1 shows a side view of a spinning type fishing reel;

FIG. 2 shows a bail arm according to one embodiment of the present invention;

FIG. 3 shows an exploded perspective view of a bail arm assembly according to one embodiment of the present invention;

FIG. 4(a)-(e) shows various exemplary shapes of the elongated hole of the present invention.

FIG. 5 (a) illustrates that the line roller screw is positioned at a distal end of the elongated hole of the bail arm to generate front heavy line lay on the spool as shown in FIG. 5 (b) and that the bottom of the line roller is positioned higher than the lower edge of the spool lip when the line roller screw is positioned at the distal end and the oscillating spool is retracted fully according to one embodiment of the present invention;

FIG. 6(a) shows that the line roller screw is positioned at a proximal end of the elongated hole of the bail arm to generate back heavy line lay on the spool as shown in FIG. 6 (b) and that the bottom of the line roller is positioned lower than the upper edge of the spool skirt when the line roller screw is positioned at the proximal end and the oscillating spool is extended fully according to one embodiment of the present invention;

FIG. 7(a) shows that the line roller screw is positioned at the center of the elongated hole of the bail arm to generate even line lay on the spool as shown in FIG. 7(b) according to one embodiment of the present invention and that the bottom of the line roller is positioned at the center of the spool drum when the line roller screw is positioned at the center and the oscillating spool is at the middle of the oscillation range according to one embodiment of the present invention; and

### DETAILED DESCRIPTION OF PREFERED ENODIMENTS

According to the invention, there is provided a spinning type fishing reel, which can be adjusted to produce different line lays such as front heavy, back heavy, or even line lay without need of any tool nor separate parts regardless of the drag system of the reel, which is accomplished by adjusting the height of line roller of a spinning type fishing reel. The line roller is attached through a screw assembly to the bail arm of the spinning type fishing reel through the bail arm's elongated hole, which allows up and down movement of the line roller. The screw assembly may include a screw and a spring lock washer to hold the line roller securely in desired position.

With such structure, when the desired line lay is front heavy, user will move the line roller to a distal end of the spool (to the top of elongated hole on the bail arm), which, as the line is wound up and spool shaft moves up and down along its oscillation range, forces the line toward the front of the spool, since the bottom of the line roller will sit higher than top edge of spool when the spool is at the lowest point of its to and fro movement, line's natural tendency to move upward is blocked by the presence of the front spool lip and thus create front heavy line lay on the spool.

Conversely, with such structure, if the desired line lay is back heavy, user will move the line roller toward a proximal end of the spool (to the bottom of elongated hole on the bail arm), which, as the line is wound and spool shafts moves up and down, forces the line toward the back of the spool, because the bottom of the line roller will sit lower than the upper edge of the spool skirt when the spool is at the highest point of its to and fro movement, line's tendency to go below the bottom of spool is blocked by the presence of spool's bottom flange and thus create bottom heavy line lay on the spool.

And if even line lay is desired, the line roller is set to the center of the elongated hole and the up and down oscillation of spool assembly would not cause the bottom of the line roller move beyond lower or upper edge of the spool lip or skirt. Thus line is wound evenly onto the spool.

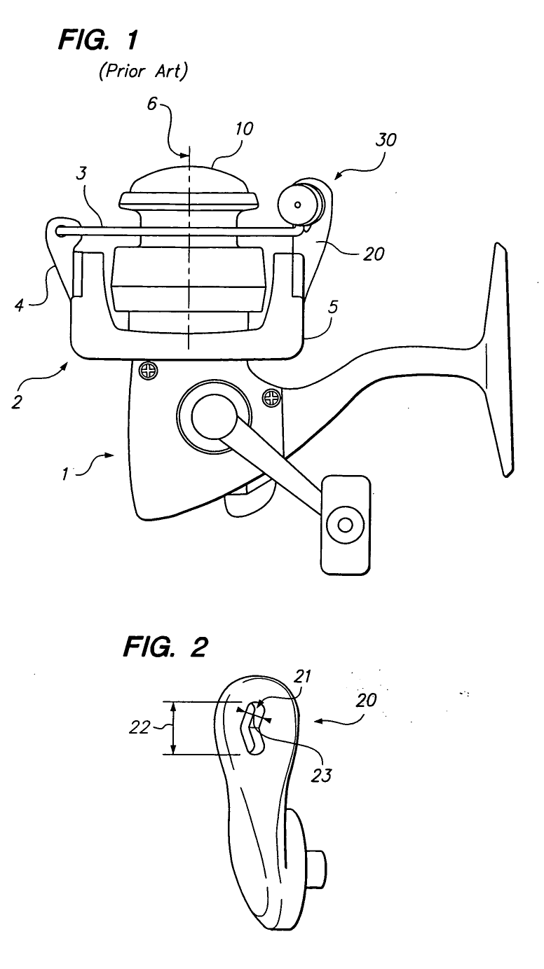

Referring to FIG. 1, a typical spinning type reel 1 includes a spool 10 having a lip 11, a spool drum 12, and a spool skirt 13 and a rotor assembly 2 having a bail arm 20, line roller assembly 30, a bail 3, a bail seat 4, and a rotor 5. When the bail arm 20 is in its closed position as shown, rotation of rotor 5 about the its rotation axes or spinning axis 6 causes fishing line to be wound on the spool 10 or unwound therefrom depending upon the direction of the rotation. As the rotor 5 rotates, the spool 10 simultaneously oscillates back and forth along the spinning axis 6 distributing the wounded fishing line evenly over the spool drum 12. For a typical spinning type reel, the oscillation range 7 of the spool is about the same as the width X of the spool drum. The bail arm 20 is attached to the rotor 5, and the line roller assembly 30 is attached to the bail arm 20 in a way that the relative location of the bottom of the line roller stays within the oscillating range 7. For example, when the spool is fully extended out, the bottom of line roller does not go behind the upper edge of the spool skirt 13, and when the spool is fully retracted, it does not go over the lower edge of the spool lip 11. And also, when the spool is at the middle of the oscillating range, the bottom of the line roller also stay at the middle of the range so that the fishing line guided by the line roller is wounded on the middle of the spool drum.

Thus, with the typical spinning type reel, the fishing line wound on the spool drum is evenly distributed over the entire width of the spool drum. When the shape of the spool drum is an evenly thick tube, the fishing line wound on it would result in even line lay. If the shape is a front heavy tube or back heavy tube, the resulted line lay would be respectively front heavy line lay or back heavy line lay. These line lay shapes, therefore are predetermined by the shape of the spool drum and cannot be altered from one shape to other without switching the spool drum.

With reference to FIG. 2, the bail arm 20 has an elongated hole, which allow shift of the line roller assembly axially along the axis of the elongated hole 21. Through this elongated hole, the line roller is attached to the bail arm by a mean of a screw. The length of elongated hole can be determined depends on the amount of the adjustment in the line lay shaping, e.g.; shorter the hole, less amount of adjustments in shaping of spool will be made, longer the hole, more amount of adjustments in spool shaping will be made.

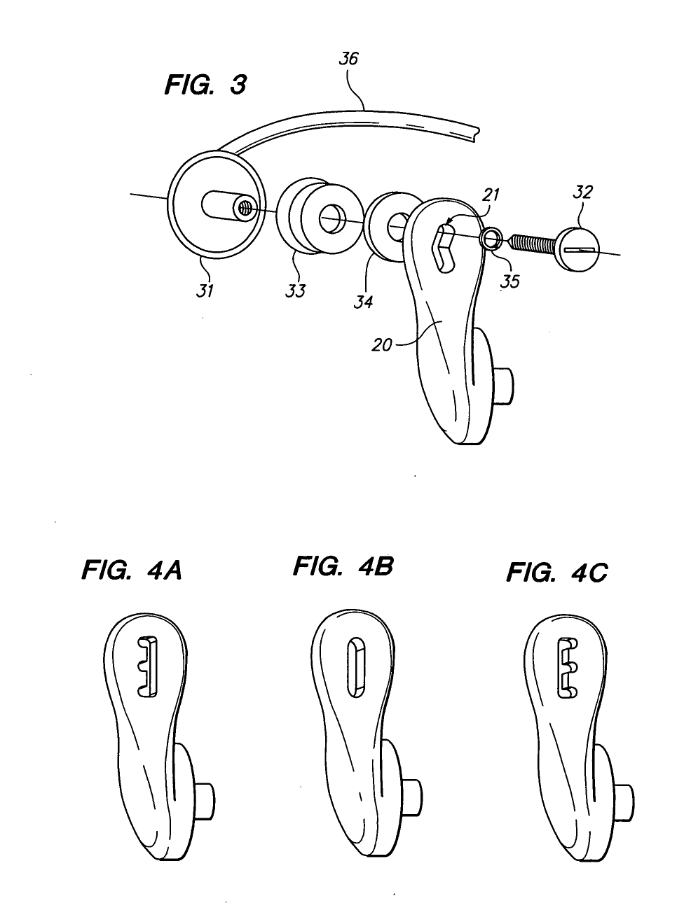

FIG. 3 shows an example embodiment of a line roller assembly 30, which is assembled together with the bail arm 20 having an elongated hole 21 according to one embodiment of the invention. In this example embodiment, one end of the bail has a line roller holder 31 having a tube type protrusion with threaded inside, to accommodate a corresponding screw 32. Onto this line roller holder, a line roller 33, with or without bearing, is mounted, and the line roller's end cover 34, if not already connected to the line roller holder, also with a hole, larger than diameter of the screw 32, but not threaded, may be placed between line roller and bail arm. The width of the elongated hole of the bail arm, instead of having a fixed hole for a screw to hold line roller in fixed position, is slightly wider than diameter of the screw that holds the line roller assembly at the other side of the bail arm. The screw is preferably a hand turnable screw or hand screw, with wide brim with grooves along the edge of brim and a slot on top to allow use of a screwdriver. A spring lock washer 35 may also be used to help hold position of the line roller in a desired position and to resist screw from sliding along the elongated hole.

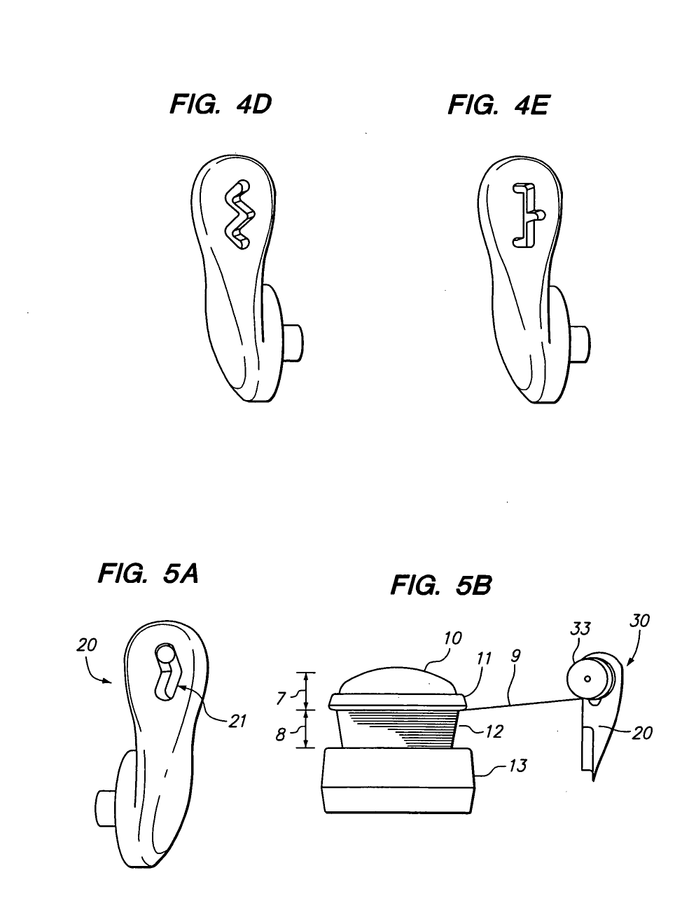

The shape of the elongated hole could be varied without affecting the advantages of the present invention. FIG. 4 shows different variations of the elongated hole shape. One example may be a Chevron type of design (“V” turned sideways) as shown in FIGS. 2 and 3, which allows easy location of the three key parking positions: the distal end, the center, or the proximal end, which respectively creates the front heaving line lay, the even line lay, or the back heavy line lay. FIG. 4 (a)-(e) show other exemplary shapes of the elongated hole. Each example is designed to have pre-fixed parkings for the screw so that the user can easily find and shift to his/her desired location. For more detailed control, a straight linear elongated hole without any pre-fixed parking or an elongated hole with more than three pre-fixed parkings may also be used as showing FIGS. 4(b) and (d).

Also, bail arm may be shaped with protruding flap at its edges to help transfer of fishing line onto the center of the line roll.

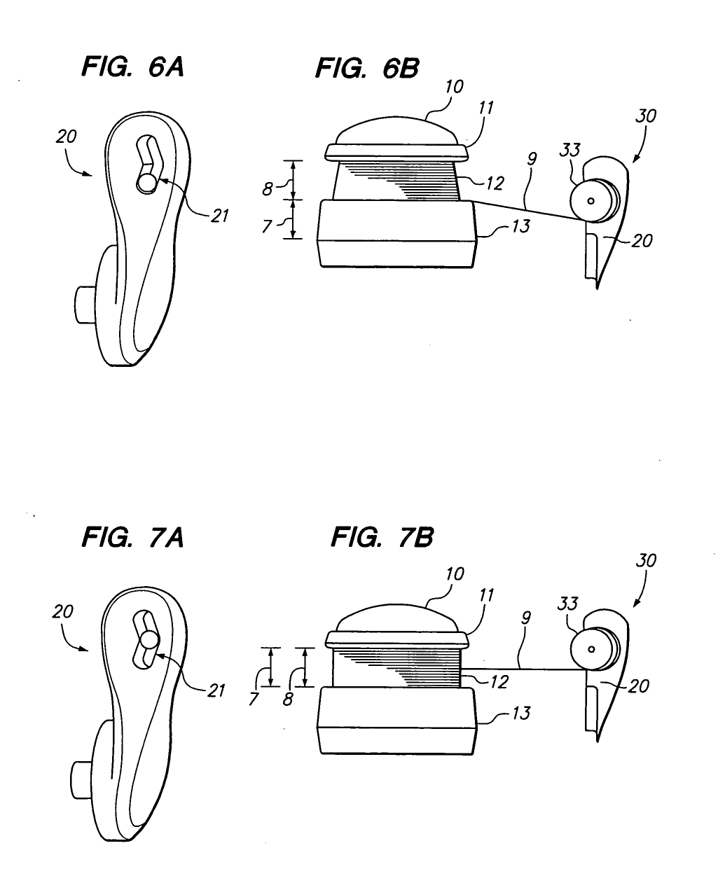

FIG. 6(a), illustrate the location of the screw at the distal end. FIG. 6(b), which is a representative drawing of the spool and the line roller assembly, illustrates that the bottom of the line roller is positioned higher than the lower edge of the spool lip 11 so that the fishing line 9 wound on the spool drum is supplied from a position that is higher than the lower edge when the spool reached the lowest limit of its oscillation range. Under this setting, the fishing line wound on the spool drum will create front heavy line lay.

Conversely, FIG. 6(a), illustrate that the location of the roller is at the lower end and FIG. 6(b) illustrates that the bottom of the line roller is positioned lower than the upper edge of the spool skirt 13 so that the fishing line wound on the spool drum is supplied from below the upper edge of the skirt when the spool reached the upper limit of its oscillation range. This setting will create back heavy line lay with the fishing line on the spool drum.

FIGS. 7(a) and (b) illustrate the setting of the exemplary embodiment of the present invention where an even line lay will be created on the spool drum. In this setting, the screw is placed at the middle of the elongated hole, which will effectively place the bottom of the line roller at the center of the spool drum when the spool is at the middle of the oscillation range.

While only selected embodiments have been describe in order to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A spinning type fishing reel comprising a spool axially reciprocating along its spinning axis as winding fishing line, a bail arm having an elongated hole, and a line roller, where the line roller and the bail arm are assembled together using a screw, which perforates the elongated hole and the line roller, wherein the location of the line roller is adjustable along the longitudinal axis of the elongate hole to alter the lay shape of the fishing line wound on the spool.

2. The spinning type fishing reel according to claim 1, wherein said elongated hole has a plurality of a prefixed parking for the screw.

3. The spinning type fishing reel according to claim 2, wherein said plurality is three.

4. The spinning type fishing reel according to claim 3, wherein said three prefixed parkings are located each at a distal end, a proximal end and a center, which are located so that the fishing line is wound up creating respectively front heavy line lay, back heavy line lay or even line lay as the location of the line roller is adjusted to each of the prefixed parkings of the elongated hole.

5. The spinning type fishing reel according to claim 4, wherein said elongated hole is in shape of a chevron.

6. The spinning type fishing reel according to claim 5, wherein said screw is a hand screw.

7. The spinning type-fishing reel according to claim 6, further comprising a spring lock washer, which provided between the bail arm and the screw.

8. The spinning type fishing reel according to claim 7, further comprising a line roller end cover wherein the line roller is provided between the line roller end cover and the bail arm.

9. A spinning type fishing reel, comprising
(a) a spool, which axially reciprocates along its spinning axis as winding fishing line;
(b) a bail arm having an elongated hole; and
(c) a line roller,
where the line roller is attached to the bail arm by screwing a screw against the line roller through the elongated hole wherein the location of the line roller is adjustable axially along the elongated axis of the elongate hole to alter the lay shape of the fishing line wound on the spool,
wherein the elongated hole has a distal end, a proximal end and a center, which are located so that the fishing line wound on the spool creates front heavy line lay, back heavy line lay or even line lay as the location of the line roller is adjusted respectively to the distal end, the proximal end, or the center.

10. The spinning type fishing reel according to claim 7, wherein said elongated hole is in shape of a chevron.

11. The spinning type fishing reel according to claim 8, further comprising a spring lock washer provided between the bail arm and the screw.

12. The spinning type fishing reel according to claim 10, further comprising a line roller end cover wherein the line roller is provided between the line roller end cover and the bail arm.
